(19) United States
(12) Patent Application Publication
(10) Pub. No.: US 2022/0009370 A1
(43) Pub. Date: Jan. 13, 2022

(54) Interactive Battery Charger for Electric Vehicle

(71) Applicants: Siddharth Suhas Kulkarni, Birmingham (GB); Prof. Rakesh Kumar Dwivedi, Moradabad (IN); Danish Ather, Greater Noida (IN); Bijoy Goswami, Guwahati (IN); Gaurang Vasantlal Shah, Mumbai (IN); Neeraj Milind Shahane, Clayton (AU); Shridhar Dhulappa Kambale, Melbourne (AU); Avi Avelino Noronha, Clayton (AU); Mihir Velapure, Clayton (AU); Biplab Kumar Sarkar, Pune (IN)

(72) Inventors: Siddharth Suhas Kulkarni, Birmingham (GB); Prof. Rakesh Kumar Dwivedi, Moradabad (IN); Danish Ather, Greater Noida (IN); Bijoy Goswami, Guwahati (IN); Gaurang Vasantlal Shah, Mumbai (IN); Neeraj Milind Shahane, Clayton (AU); Shridhar Dhulappa Kambale, Melbourne (AU); Avi Avelino Noronha, Clayton (AU); Mihir Velapure, Clayton (AU); Biplab Kumar Sarkar, Pune (IN)

(21) Appl. No.: 17/384,711

(22) Filed: Jul. 24, 2021

(51) Int. Cl. B60L 53/63; B60L 55/00; B60L 53/66; B60L 53/65

(52) U.S. Cl. CPC B60L 53/63; B60L 53/65; B60L 53/66; B60L 55/00

(57) ABSTRACT

The present invention relates to device for electrical Vehicle may be a Negative impact from the dominant use of petroleum-based transportation have propelled the world towards electrified transportation. With this thrust, several technological challenges are being encountered and addressed, one among that is that the development and convenience of fast-changing technologies. To vie with petroleum-based transportation, electrical vehicle (EV) battery charging times have to be compelled to decrease to the 5-10 min vary. The invention projected the look of a system to make and handle electrical Vehicles (EV) charging procedures, supported intelligent method. because of the power distribution network limitation and absence of sensible meter devices, electrical Vehicles charging ought to be performed in an exceedingly balanced manner, taking under consideration past expertise, weather info supported data processing, and simulation approaches. so as to permit info exchange and to assist user quality, it had been conjointly created a mobile application to help the heat unit driver on these processes. This fictional sensible electrical Vehicle Charging System uses Vehicle-to-Grid (V2G) technology, so as to attach electrical Vehicles and conjointly renewable energy sources to sensible Grids (SG). this technique conjointly explores the new paradigm of Electrical Markets (EM), with release of electricity production and use, so as to get the simplest conditions for commercializing voltage.

### FIELD OF THE INVENTION

Our Invention is related to an Interactive Battery Charger for Electric Vehicle.

### BACKGROUND OF THE INVENTION

The power quality deterioration, increased broken off line, worsening of distribution transformers, raised distortion and better fault current. One economical approach to alleviate the result is to integrate native power generation like renewable energy sources (RESs) into the electron volt charging infrastructure.

In the past few decades there has been a gentle transition from petroleum-based to electric-based transportation altogether sectors, as well as craft, trains, ships, and electrical vehicles (EVs). This shift is anticipated to speedily advance, notably with EVs, because the advantages, political incentives.

The falling costs, as well as because of large-scale production, aforesaid the market. The U.S. Energy data Administration states that the planet has Associate in Nursing adequate oil provide till concerning 2050. Clearly, alternatives to fossil fuels got to be developed for transportation, electricity generation, etc.

For transportation, EVs are a recognized answer and still become wide accepted because the technology develops and economic practicableness becomes a reality. EVs supply raised potency (energy savings) through higher fuel economy, reduced emissions/pollution (especially once the electricity is generated from renewable resources, like wind and solar).

EVs facilitate the U.S. to own a bigger diversity of fuel selections for transportation. most U.S. electricity is created from domestic sources, as well as gas, coal, nuclear, and renewable sources.

This new reality brings extra issues, such as:
1. overload of voltage distribution network, if there's a substantial quantity of EVs charging at a similar time;
2. home consumption and written agreement power limitation;
3. shopping for electricity at lower costs once renewable energy is created in excess, and commerce electricity at higher costs once the demand for energy is superior to the supply within the electrical network.

The good Grids with mensuration devices and a communication infrastructure, among different devices, is an element of an answer for this downside in an exceedingly close to future, and so, the proposal here given may facilitate the creation of SG (because it's doable to perform some functions connected with the management of power obtainable within the electrical network supported historical data).

The projected system, integrated on a SG, additionally may execute tasks connected with EM (finding the hours with best costs for charging or discharging the electron volt batteries, and different home customized functions).

### OBJECTIVES OF THE INVENTION

1. The objective of the invention is to an Interactive Battery Charger for Electric Vehicle is a Negative impact from the dominant use of petroleum-based transportation have propelled the globe towards electrified transportation.
2. The other objective of the invention is to an also with this thrust, many technological challenges are being encountered and addressed, one of which is the development and availability of fast-changing technologies.
3. The other objective of the invention is to a compete with petroleum-based transportation, electric vehicle (EV) battery charging times need to decrease to the 5-10 min range and also the invention proposed the design of a system to create.
4. The other objective of the invention is to a handle Electric Vehicles (EV) charging procedure, based on intelligent process and Due to the electrical power distribution network limitation.
5. The other objective of the invention is to a smart meter devices Electric Vehicles charging should be performed in a balanced way taking into account past experience, weather information based on data mining and simulation approaches.
6. The other objective of the invention is to an allow information exchange and to help user mobility it was also created a mobile application to assist the EV driver on these processes.
7. The other objective of the invention is to an invented Smart Electric Vehicle Charging System uses Vehicle-to-Grid (V2G) technology in order to connect Electric Vehicles and also renewable energy sources to Smart Grids (SG).
8. The other objective of the invention is to a system also explores the new paradigm of Electrical Markets (EM) with deregulation of electricity production and use in order to obtain the best conditions for commercializing electrical energy.

### SUMMARY OF THE INVENTION

To maximize the reduction of parts, range and therefore to more scale back the scale, weight and value of the device many integrated topologies are projected and studied in literature. The thought of integration consists of reusing a number of the drivetrain parts (inverter and motor windings) to implement the on-board charging system.

However, some issues could have born from this combination: the configurations projected in needed access to inaccessible points of the motor windings, in an exceedingly arrangement of the motor windings is important throughout the transition between completely different operation modes.

Finally, by mistreatment the charger configuration projected in even though neither access to the neutral purpose of the motor windings nor their arrangement are needed, the management of the active switches becomes harder.

The General Motors (GM) EV1 was one among the primary mass created EVs of the trendy era. In 1996, the first-generation models were free with a sixteen.5 kWh accumulator and a golf range of sixty miles.

This automotive had many completely different charging capabilities, as follows: A half-dozen.6-kilowatt charger that took three h to utterly charge the battery, a 1.2-kilowatt charger that took fifteen h to totally charge, and, later, a fifty-kilowatt charger was developed that might charge the battery from two hundredth to eightieth of full charge in 10-15 min.

Fast-forwarding to nowadays, the 2018 weight unit beset Bolt features a sixty-kWh lithium-ion (Li-ion) battery and a golf range of 238 miles.

The Bolt has three charging choices, as follows: Basic charging utilizes a hundred and twenty V wall outlet and offers ˜48 miles per twelve h of charge time (˜1 kW), fast-charging could be a 240 V possibility that charges at seven. 68 kW, and super-fast charging could be a DC charging possibility that replenishes the battery at ˜50 kilowatt.

As a consequence of the rise in battery capability and, thus, golf range, charging the Bolt's sixty-kilowatt battery at the super-fast charging rate of fifty kW takes one h and fifteen min. Therefore, whereas electron volt driving ranges became competitive with burning engine vehicles (ICEVs), the recharge/refuel times still lack compared.

As electron volt technologies improved and electrified transportation has become additional widespread, a requirement for standardized charging ports has developed. even as a driver of an interior combustion engine vehicle (ICEV) will extra service at any filling station, a similar want arose for EVs.

Even today, an absence of charging port standardization could be a major hurdle that's holding back electron volt adoption, because the numerous electron volt makers still use completely different charging port configurations. The Society of Automotive Engineers (SAE) exists with the aim of uniting and developing technologies by making business accepted standards.

Current Limit It ought to be any noted that because the charging method takes place, a layer of conductor material that's “charged” starts to grow, and thru that the Li+ ions currently got to diffuse, retardation down the charging rate.

A battery charges for a given over potential decreases and one is also tempted to just increase the applied over potential to revive quicker rates of charging. There's naturally a limit to the over potential that may be applied. It's acknowledged that Li-ion batteries are broken once an exact higher voltage limit is exceeded, because of the incidence of unsought secondary chemical science reactions.

The higher voltage threshold is exceeded in LiNi2O4 primarily based batteries, a second section is made because of the migration of atomic number 28 ions to Li vacancies, for good reducing the capability of the battery.

Our investigation proposal is to bring engineering science work on package development, Web 2.0, geographic info systems, mobile computation and wireless communication, to a replacement growing space of sensible Grids (SG) and energy unit (Electric Vehicle).

The increasing complexness and variety of choices, users in Electrical Markets (EM), once playing AN energy unit charging method, can want the assistance from package application, chiefly to mobile devices. thus, our proposals, conferred during this invention, are the conception and also the creation of a mobile application and close system, to assist users on energy unit charging or discharging method, and conjointly on EM participation.

### BRIEF DESCRIPTION OF THE DRAWINGS

FIG. 1: Interactive Battery Flow.

FIG. 2: Battery Charger for Electric Vehicle Process.

FIG. 3: Battery Charger for Electric Vehicle Complete Process.

### DETAILED DESCRIPTION OF THE DRAWINGS

Temperature knowledge is said with electricity consumption, and also the alternative parameters are related to renewable energy production: wind to Aeolic, temperature and radiation to electrical phenomenon, and rain to Hydropower production.

The area with the distribution of the electrical network is manually reworked in an exceedingly graph, wherever we tend to add geographic info and power limitation between the nodes. this can be a slow method wherever we tend to expect in an exceedingly close to future to introduce some automation.

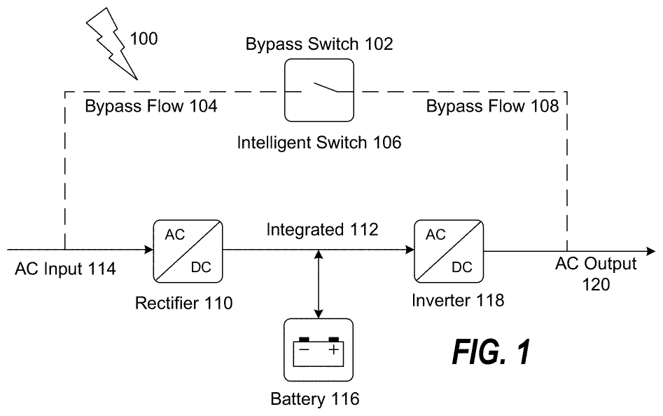

FIG. 1: Interactive Battery Flow.

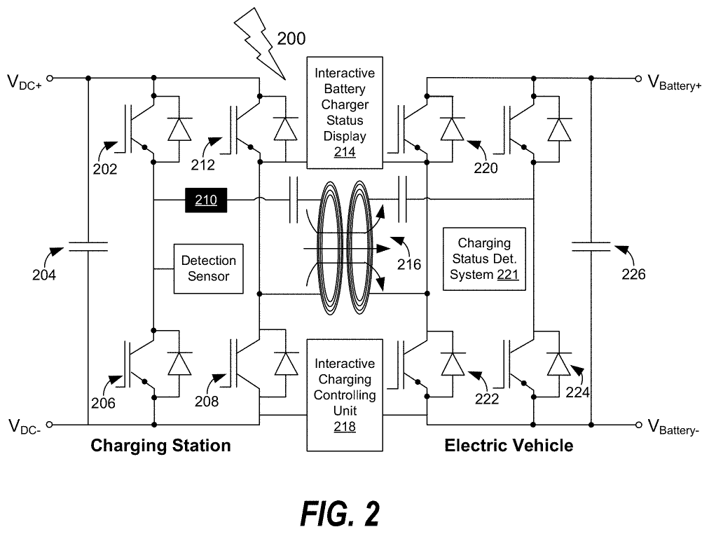

FIG. 2: Battery Charger for Electric Vehicle Process.

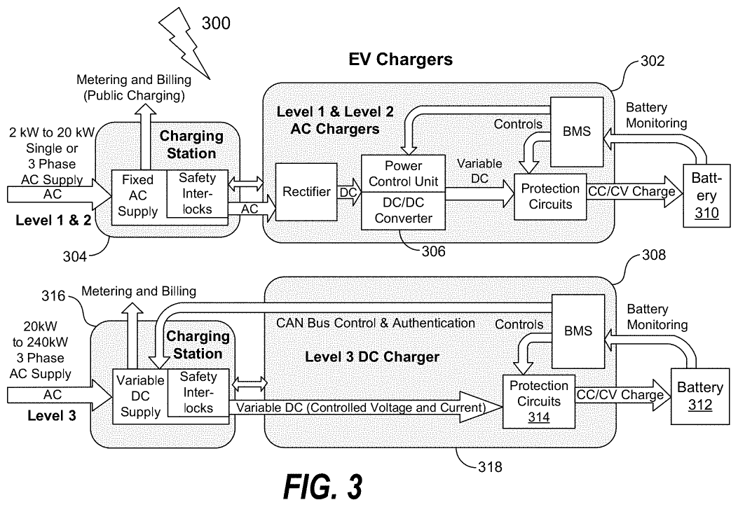

FIG. 3: Battery Charger for Electric Vehicle Complete Process

Assumptions on consumer's behavior are considered:
1. customers outline their house and family (number of house divisions, variety of persons;
2. They outline the amount and kind of electrical appliances from a pre-defined list;
3. They outline conjointly their usual routine (arrival time, departure time). following system knowledge will tune arrival and departure times.

Each client has its own behavior and changes or sudden behavior are indiscriminately generated at the start of the experiment, mistreatment AN array of integers. every client is delineated by AN agent UN agency is aware of written agreement power limitation and conjointly the distribution.

On the simulation tool (Net log) we tend to follow a bottom-up approach wherever we tend to estimate consumption supported client profile and historical consumption knowledge. Weather info (temperature) is employed as a proportion increase issue on usual consumption.

Every client is delineated by AN agent that's supported historical knowledge, profile and temperature info, supported a random perform for energy consumption, that is calculable at each quarter-hour (this interval is configurable).

The agent contains a utility perform; however, the agent isn't optimizing it as a result of this method is simply too high-priced below several aspects: in terms of knowledge retrieval value, in terms of knowledge process prices from a machine purpose of read, and in terms of psychological feature effort in looking out alternatives.

We tend to attempt to model every client as a node on a network distribution graph. Simulation takes under consideration house power limitation contract and electricity distribution limitations.

Interpreter of Downloaded Files—

This module is going to be chargeable for reading and deciphering the files loading, giving the system a layer of abstraction over the file format of text issued by the loading system;

Sensible Grid Interface—

This module is going to be chargeable for the interaction with the electrical network, i.e., it controls the flow of energy from or to the electrical network, with the objectives of serving to network stability, and also, managing info on the variation of electricity costs, to optimize the profits obtained with the commerce of energy to the electrical network;

User Manager—

This module is chargeable for registering the users and their EVs, permitting the recording and redaction of users knowledge, likewise because the removal of users (if outlined rules don't seem to be accomplished by specific users)—this module is additionally chargeable for verification of user identity and possession of registered vehicles (through the transmission of knowledge received from the user to the authorities), and for playing regular cleansing from the information of users classified as “spam”;

Manager Profiles—

A user will set one or a lot of load profiles for every of the vehicles registered by him. a standard observe is, for instance, the definition of profiles and wishes of various charging to be administrated throughout the week (weekdays) over the weekend; and (5) Manager Central—consists within the main module of the V2G sensible System, interacting with varied modules mentioned on top of, and managing the distribution of system information.

The last sort of projected OBC area unit the therefore known as multifunctional OBCs. during this sort of charger some elements area unit shared to accomplish totally different aims. during this manner higher fuel potency may be reached by smaller and lighter style.

Within the projected multifunctional charger will charge the auxiliary battery via the propulsion battery once the vehicle is in an exceedingly driving state, acting during this manner as associate OBC and as low-tension dc-to-dc device (LDC) put together. in an exceedingly similar configuration, with a similar duty is given.

To reduce the practice range anxiety and thence to support a stronger increase of the penetration of EVs worldwide there's the requirement of a charging system that is in a position to interchange the present existing oil station.

a quick charging station (FCS) will permit the charging of associate energy unit at eightieth at intervals a ½ hour from its depletion, however to scale back the charging time from 7-8 h to thirty min, FCS needs high power from the grid and for this reason typically connected to the MV network although some FCS connected to the 55 grids are projected too.

The association of such charging stations needs an enormous capital investment and it may simply overload the distribution network. Another important side to be thought-about consists within the free fall that the association of FCS will cause on the lines of the distribution networks, that consistent with the quality EN50160 must stay under 100 percent.

This invention provides a review of EV fast-changing technologies and the impacts on the battery systems, including heat management and associated limitations. In addition, the invention presents promising new approaches and opportunities for power electronic converter topologies and systems level research to advance the state-of-the-art in fast-charging

1) An Interactive Battery Charger for Electric Vehicle, the vehicle comprising:
a sensible grid Interface module, the module is going to be chargeable for the interaction with the electrical network;
a User Manager module chargeable for registering the users and their EVs, permitting the recording and redaction of users knowledge, likewise because the removal of users
a profile manager module for storing a load profiles for every of the vehicles registered, wherein the user manager module controls flow of energy from or to the electrical network, with the objectives of serving to network stability, and also, managing info on the variation of electricity costs, to optimize the profits obtained with the commerce of energy to the electrical network;

2) The vehicle of claim 1, wherein the user manager module is additionally chargeable for verification of user identity and possession of registered vehicles.

3) The vehicle of claim 1, wherein the user manager module is additionally chargeable through the transmission of knowledge received from the user to the authorities), and for playing regular cleansing from the information of users classified as “spam”.

4) The vehicle of claim 1, wherein the definition of profiles and wishes of various charging to be administrated throughout the week (weekdays) over the weekend; and (5) Manager Central—consists within the main module of the V2G sensible System, interacting with varied modules mentioned on top of, and managing the distribution of system information.

5) The vehicle of claim 1, wherein the vehicle attaches electrical Vehicles and additionally renewable energy sources to sensible Grids (SG).

6) The vehicle of claim 1, wherein the vehicle is operated by a mobile application to assist the EV driver on these processes and also this invented Smart Electric Vehicle Charging System uses Vehicle-to-Grid (V2G) technology, in order to connect Electric Vehicles and also renewable energy sources to Smart Grids (SG).
